(19) United States
(12) Patent Application Publication
(10) Pub. No.: US 2024/0042465 A1
(43) Pub. Date: Feb. 8, 2024

(54) SYSTEM FOR A SHOWER HEAD, WITH A ROTARY BODY, FLOW REGULATOR, HINGED ARM, WALL MOUNT AND REINFORCED CONNECTOR

(71) Applicant: Marco Antonio GARCÍA VILLAREAL, Monterrey, Nuevo Leon (MX)

(72) Inventor: Marco Antonio GARCÍA VILLAREAL, Monterrey, Nuevo Leon (MX)

(21) Appl. No.: 18/266,647

(22) PCT Filed: Dec. 11, 2020
(86) PCT No.: PCT/MX2020/000053

§ 371 Date: Jun. 12, 2023

(51) Int. Cl. B05B 1/18

(52) U.S. Cl. CPC B05B 1/185

(57) ABSTRACT

The present invention is a shower head system that includes various components such as a rotary body, flow regulator, hinged arm, wall mount, and reinforced connector. The system allows for unlimited circular movement of the arm's tubular segments through hinges. Methods for installation and adjustment of resistive force within and outside the hinges are provided to control the relative movement between the tubular segments. To ensure structural strength, a reinforced connector and a plate mount with a seal are incorporated. A specially designed hinge, consisting of two perfectly fitting parts (male and female), is attached to the connector using a small tube. Axial resistive force means are applied to a screw passing through the hinge parts, preventing free-falling of the tubular segments when the hinge is loosened. This system also ensures the safety of the tubular segments by securely trapping them with the screw, eliminating the risk of accidental detachment. The farthest tubular segment includes a rotary body with a male spray regulator that can accommodate a shower head holder with a male thread and other shower heads with a female thread.

System for shower head, with rotating body, flow regulator, articulated arm, wall bracket and reinforced connector.

### FIELD OF INVENTION

This application refers to a system for a shower head, with a rotating body, flow regulator, articulated arm, wall support and reinforced connector. Particularly, the present invention relates to a hinge for an articulated shower head arm and to methods for installing and adjusting the resistive force within the hinge to inhibit or allow relative movement between the tubular segments of the arm. The present application further relates to methods for structuring and supporting the shower head articulated arm system by fixing it to a surface and connecting it to the hydraulic water supply installation.

### BACKGROUND OF THE INVENTION

Currently, shower heads are installed on a water-conducting arm that is placed on the wall of a bathroom and is a continuation of the hydraulic installation of a house, this arm is typically a tube with a certain angle, threaded At both ends, one end is installed on the thread that provides the hydraulic installation of the bathroom and at the other end a shower head is installed. The typical installation of a shower head in a bathroom includes a means of transmitting the water, which, in this case, is usually a tube with an angle in which a shower head is installed. The angle of the tube allows the shower head and rain beam to be directed towards the user. There are also straight arms with a short bend at one end of approximately 90° to allow the rain beam to fall vertically.

On the other hand, it is important to point out that when placing modern shower heads in the aforementioned tubes, the most that can be expected in terms of movement, positioning and direction of the rain beam is: a limited movement coming from the rotation of a ball joint that modern shower heads bring as an accessory and that is limited by a fixed center in the axis of the ball joint.

There are articulated arms that provide a circular movement from the point of connection with the tube that is previously installed, that would be the axis of circular movement. They are generally single-extension arms, with a female connection at one end that is incorporated into the commonly used shower head arm and with a male connection at the other end, which receives a shower head; having next to each connection, an elbow that allows the circular movement of the arm to place the shower head in the desired position: The movement of said arm is limited to a radius of approximately 180 being the wall where it is installed the limit of the arm movement. Patent application US2005/0055765 A1, now abandoned, is considered to be the state of the art closest to the System for a shower head, with a rotating body, flow regulator, articulated arm, wall support and reinforced connector presented here, object of the application for this patent; where it can be seen that its mechanism allows the pivoting movement between its links, although in its background they mention that they solve a previous technique very similar to the one presented by said application, where the resistance force of the bolt lies in the fact that it is part of one of the links being joined to the other link closely providing a tight fit. This resists relative movement between the two links, so the connection is less likely to twist or loosen.

While such a mechanism can provide the tight fit that holds a large, heavy showerhead in one position, when it is required to adjust the position of the showerhead and use the wing nut to loosen the tightness that holds the showerheads together. mentioned links, the large and heavy shower head can fall on the user, since it completely releases the tightening mechanism that joins said links, allowing relative movement between them since it does not have a resistance force between the bolt and the links.

There are arms for shower heads with hinges on the market that allow limited circular movement, as shown in patent US802482282, this articulated arm fora shower head connects directly to a common arm that is already installed in a bathroom. bathroom and incorporates two elbows, therefore, the movement it offers is limited to a radius of approximately 180°, due to the fact that the wall of the bathroom where is installed is the limit of its circular movement and its knurled adjustment mechanism does not provide smooth movement of the arm. Although said patent offers a solution, it is very limited with respect to the need to adjust the movement of the arm and safety to prevent an accident to the user in the shower. The locking mechanism may include two sets of splines or similar structures such that when the sets of splines engage, the relative position of the arm and elbow portions locks securely in place, on the contrary, if the splines are uncoupled, the arm portion is free to rotate about the long axis of the elbow portion, this may cause the arm to come loose and fall on the user, because the bolt has no resisting force relative to the elbow. On the other hand, in the design of the elbow it is observed that the long tube is only secured with a small part of its end and the joining method is by welding. Observing this design, there is a risk factor of rupture due to the efforts that are applied to said joints with each movement, being able to detach and fall on the user.

In U.S. Pat. No. 9,700,909, ratchet mechanisms are also used in the elbows, in such a way that it is necessary to disengage the assembly from the elbow to adjust the position of the shower head. Undocking releases the elbow mechanism, so if you have a large, heavy shower head, it can fall on the user's head or any part of their body. The joint between the pre-installed angle arm and the swing arm assembly is a reinforced nut that provides a little more security than swing arms that attach to the swing arm with regular nuts. Patent AU2006200706 A1 also provides a much more limited articulated arm than the aforementioned patent.

U.S. Pat. No. 9,568,132 shows an articulated arm system for faucets, where the movement adjustment mechanism can be used in an articulated arm for a shower head, this mechanism is very sophisticated, it incorporates multiple parts in the clutch. Due to its characteristics and its purpose, it is not designed to support a large and heavy shower head, since the clutch for its fast movement function required in a sink does not require a fixed position, so it has dispensed with an adjustment system and fixing as is commonly a tightening wing nut.

The adjustment mechanisms in the different patents and applications described above are mechanisms that, although they work in part, generate other types of needs and problems, since, if they contain a large and heavy shower head, they would be causing a risk to the user. user since said mechanisms at a given moment can be overcome and cause an accident, since the long tube with the shower head can fall on top of the user or in some other part of his body.

Likewise, in said previously filed applications and patents, it can be seen how said articulated arm is joined to the previously installed common arm by means of a simple nut, or as in patent application US2005/0055765 A1, the arm is secured to the hydraulic installation by means of a simple nut, this being its only support structure. Observing the need to provide a System for shower heads, with a rotating body, flow regulator, articulated arm, wall support and reinforced connector that provides safety to the user, as well as a wide range of movements of the tubular segments of the arm to place the shower head in the desired position and thus generate a more pleasant and comfortable bathroom, we thought of this shower head system that is described below and that in turn can be used as a device that provides versatility in terms of positioning of the shower head that allows each user to obtain the comfort that most satisfies them as well as the safety of their physical integrity when showering, also solving the specific needs of users with disabilities, the sick or children.

Therefore, it is intended to protect said System for a shower head, with a rotating body, flow regulator, articulated arm, wall support and reinforced connector, by means of this application, since it is a system with two or more tubular segments with a better security mechanism in the hinges, which due to its circular seals placed on the screw; in the tubular segments provides a radial resistance force that helps support the tubular segments of the articulated arm even when the mechanism is released by loosening the lever nut and also provides structural support in the installation, thanks to its reinforced connector and support. of plate, provides greater comfort for the user and a greater range of positions for the shower head, due to the relative movement between the tubular segments and its rotating body. It also has a water flow regulator.

In a special embodiment, a shower head system has been provided, with a rotating body, flow regulator, articulated arm, wall support and reinforced connector with a first tubular segment twice the size of the second tubular segment, this with the main purpose of providing a solution to the special needs of a certain type of user, whether they are disabled or due to some illness that forces them to take their shower sitting down, or if a jet somewhere lower in the body. This special embodiment is also suitable for the children's shower as it is adapted to the average height of a child. The ratio between the tubular segments in this case is two to one between the first tubular segment and the second tubular segment, not being limiting since it can vary according to the needs of the user.

The characteristic parts and details of this System for shower head, with rotating body, flow regulator, articulated arm, wall bracket and reinforced connector are clearly shown in the following description and in the accompanying drawings.

### BRIEF DESCRIPTION OF THE FIGURES

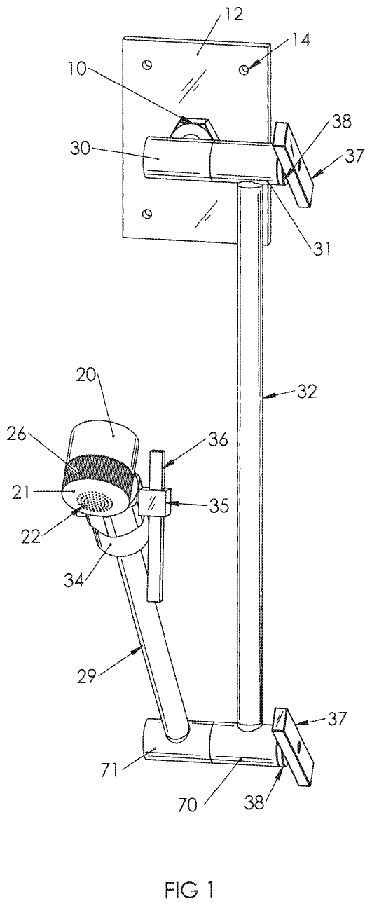

the FIG. 1 is an isometric view of the Showerhead System, with rotating body, flow regulator, articulated arm, wall bracket, and reinforced connector.

the FIG. 2 is a side view of the Shower Head System, with swivel body, flow regulator, articulated arm, wall bracket and reinforced connector

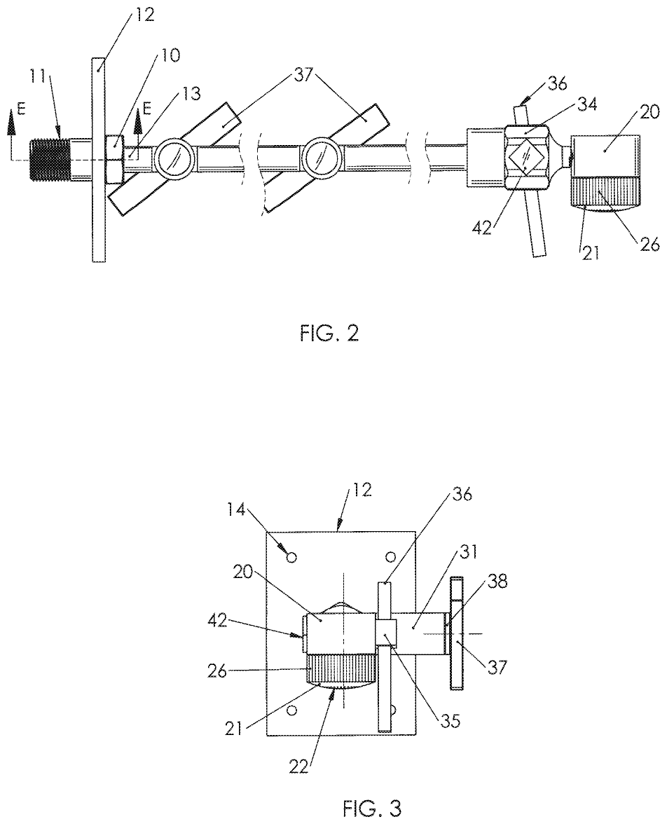

the FIG. 3 is a front view of the Shower Head System, with a rotating body, flow regulator, articulated arm, wall bracket and reinforced connector.

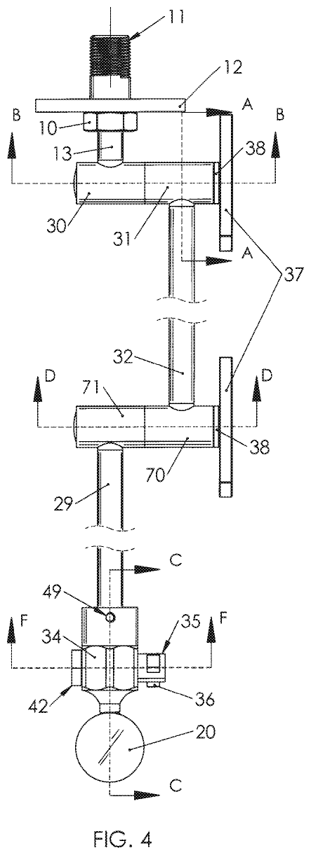

the FIG. 4 is a top view of the Shower Head System, with swivel body, flow regulator, articulated arm, wall bracket and reinforced connector.

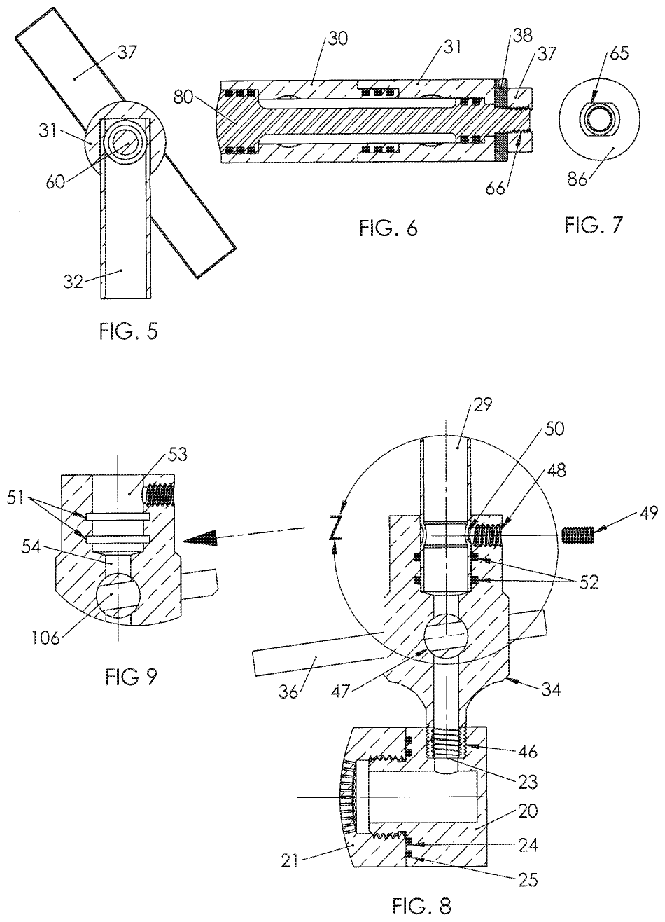

the FIG. 5 is a sectional view of the section A-A of the hinge.

the FIG. 6 is a sectional view of the B-B section of the hinge.

the FIG. 7 is a side view of the hinge showing the shape of the hole with flat parallel faces.

the FIG. 8 is a section view C-C of the rotating body with regulator.

the FIG. 9 is a sectional view of detail Z of the rotating body.

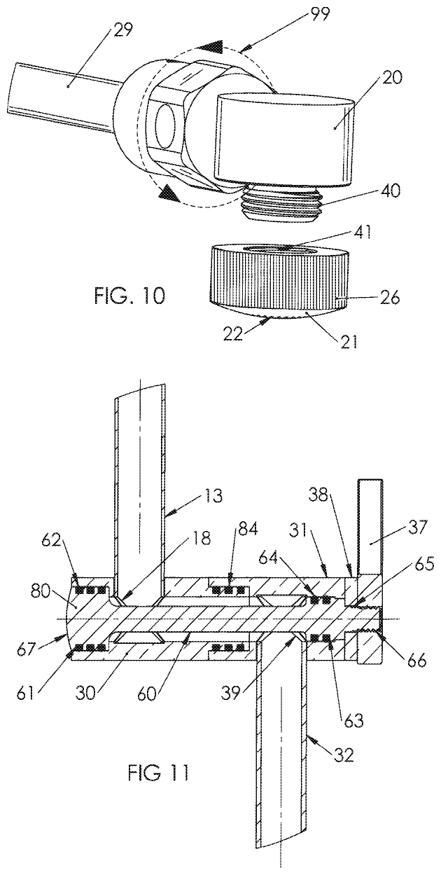

the FIG. 10 is an isometric view of the showerhead and showerhead separated to show the male threading of the showerhead and the female threading on the showerhead, as well as the 360° movement of the rotating body.

the FIG. 11 is a sectional view of the DD section of the hinge.

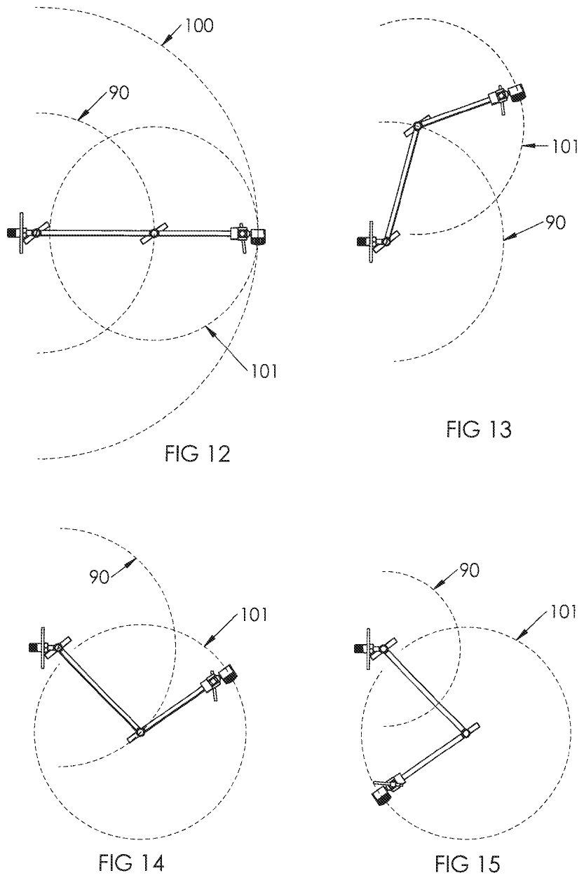

the FIG. 12 is a side view of the Shower Head System, with a rotating body, flow regulator, articulated arm, wall support and reinforced connector, extended in a horizontal position, showing the possible movements of each tubular segment by means of dotted lines.

the FIG. 13 is a side view of the shower head system, with a rotating body, flow regulator, articulated arm, wall support and reinforced connector, with the first tubular segment at an angle of approximately 60° and the second tubular segment at an angle of approximately 60°. approximately 30°, which shows through the dotted lines, the possible movements of each tubular segment.

the FIG. 14 is a side view of the Shower Head System, with rotating body, flow regulator, articulated arm, wall bracket and reinforced connector, with the tubular segments at an approximate 45° angle below the horizontal line, shown by dotted lines the possible movements of each tubular segment.

the FIG. 15 is a side view of the Shower Head System, with swivel body, flow regulator, articulated arm, wall bracket and reinforced connector showing the first tubular segment angled 45° below the horizontal line and the second segment tube also at 90° to the first tube segment, showing through dotted lines the possible movements of each tube segment.

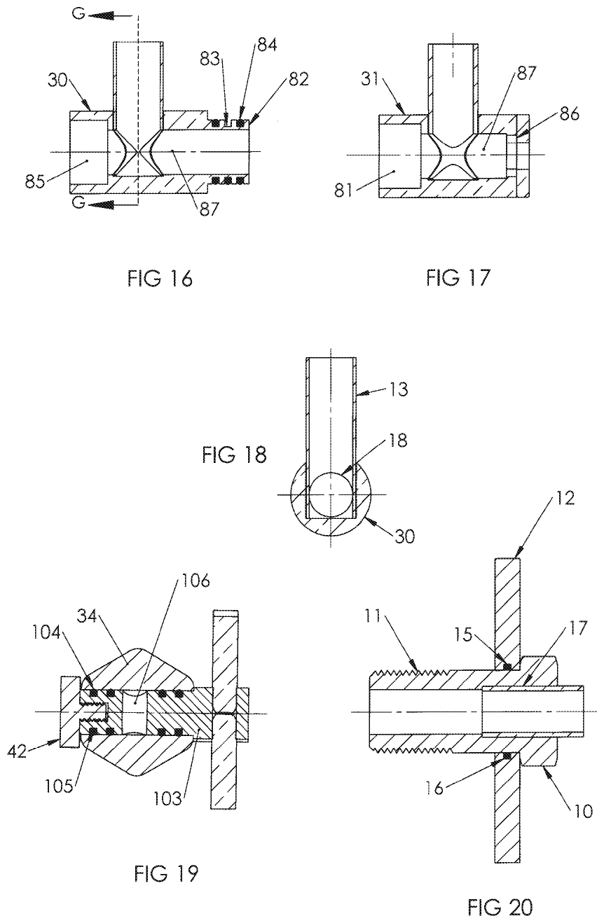

the FIG. 16 is a detailed view of the DD section of the hinge.

the FIG. 17 is a detail view of the D-D section of the hinge.

the FIG. 18 is a sectional view of the G-G section of the hinge.

the FIG. 19 is a sectional view of the section F-F of the rotary body with regulator.

the FIG. 20 is a sectional view of the E-E section of the reinforced connector and support plate.

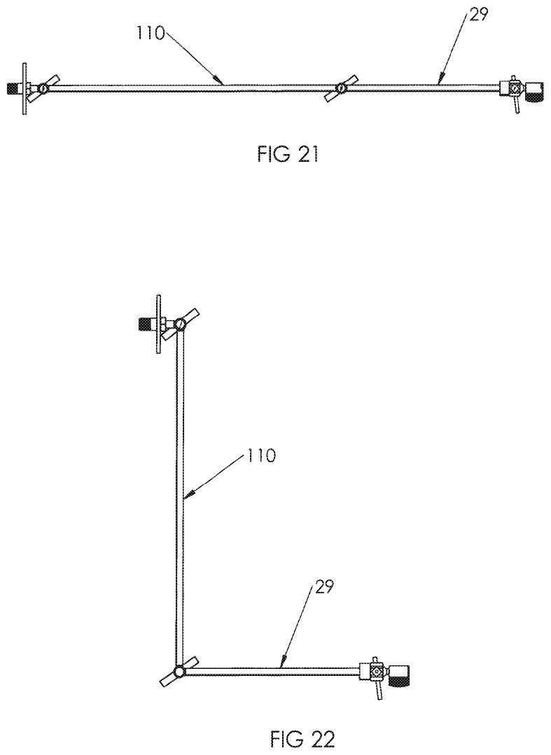

the FIG. 21 is a side view of the Shower Head System, with a rotating body, flow regulator, articulated arm, wall support and reinforced connector extended in a horizontal position, showing a special embodiment with the first tubular segment twice the size of the second tube segment.

the FIG. 22 is a side view of the Shower Head System, with a rotating body, flow regulator, articulated arm, wall support and reinforced connector that shows a special embodiment with the two tubular segments, forming a right angle.

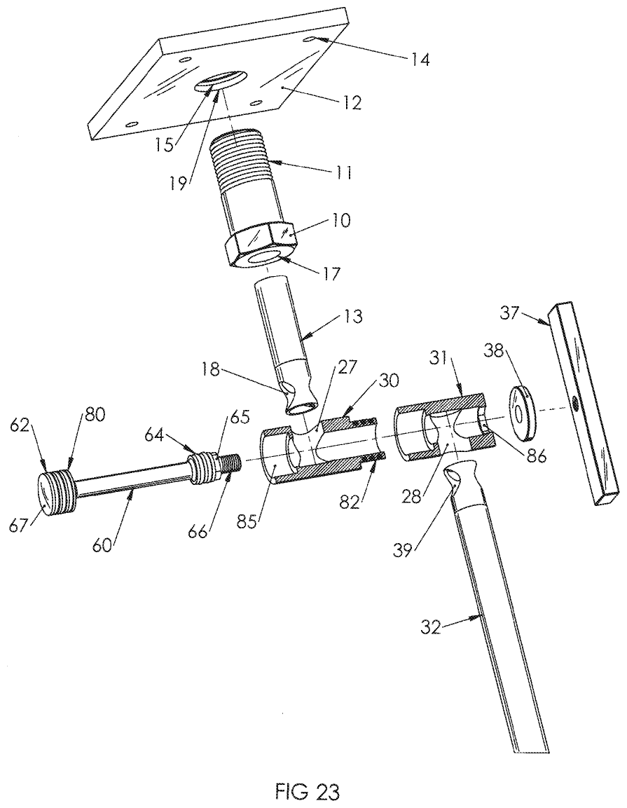

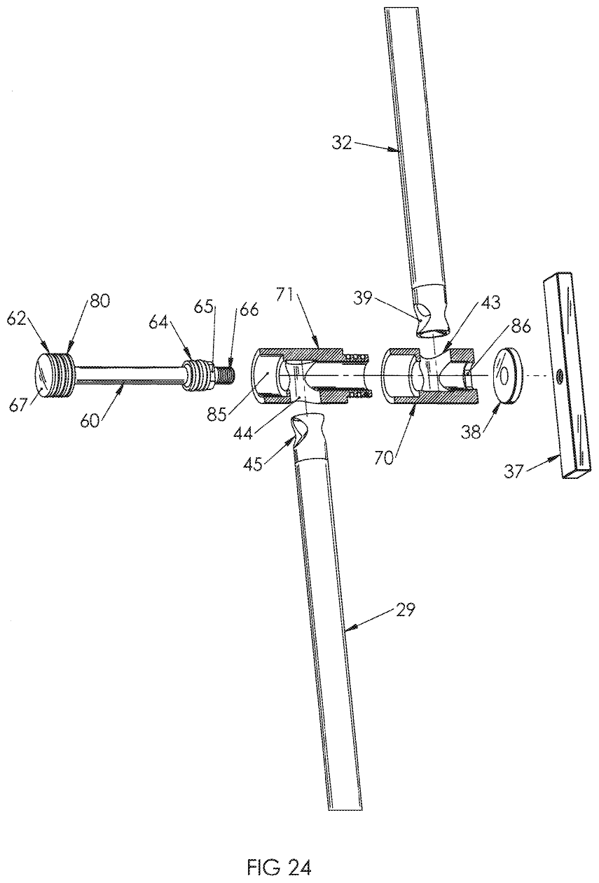

the FIG. 23 is an isometric sectional view of the Shower Head System, with rotating body, flow regulator, articulated arm, wall support and reinforced connector, showing the support plate, the reinforced connector, the first short tubular segment, to the hinge and its parts, as well as to the first long tubular segment.

the FIG. 24 is a sectional isometric view of the Shower Head System, with rotating body, flow regulator, articulated arm, wall bracket and reinforced connector, showing the first long tubular segment, the hinge and its parts, as well as the second long tubular segment.

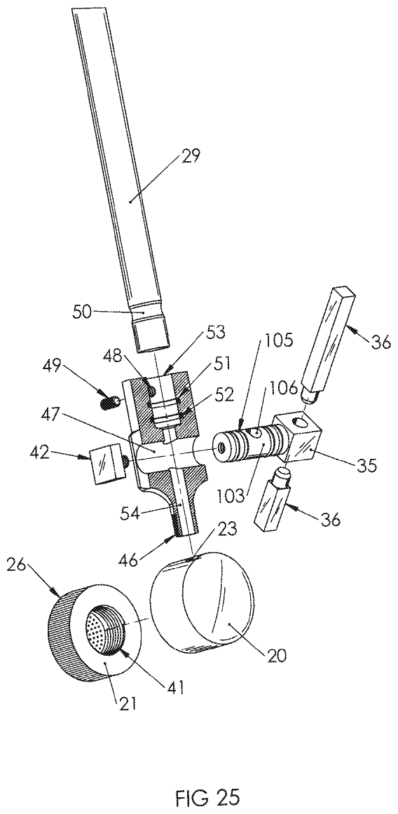

the FIG. 25 is a sectional isometric view of the Shower Head System, with rotating body, flow regulator, articulated arm, wall support and reinforced connector, showing the second long tubular segment, the rotating body with regulator and its parts, shower head holder, as well as the shower head.

### DETAILED DESCRIPTION OF THE INVENTION

The shower head system, with a rotating body, flow regulator, articulated arm, wall support and reinforced connector referred to in the present invention, is of the type that have the means that allow relative movement between segments tubular to place the shower head in the position desired by the user and is made up of a reinforced connector with a hexagonal head (10) to which a thread has been incorporated male (11), this reinforced connector is inserted into the hole (19) of the support plate (12) that has a slot (15) where a seal (16) is added that is in contact with said connector, the support plate (12) is installed on the bathroom wall by any available means, either by expander type screws (not shown) installed in the holes (14) or is adhered to the wall by means of special adhesives engineering or by any other means that allows fixing said support plate (12) to the wall. This first set of reinforced water supply connector with support plate gives the necessary resistance to the shower head system to withstand the stresses to which it is subjected by daily use. In the reinforced connector (10) a short tubular segment (13) is inserted into the hole (17) and is welded or joined by special engineering adhesives, said short tubular segment (13) is inserted into the hole (27) of the male part of the hinge that is fixed (30) and is solid or adhered with special engineering adhesives. Once inserted and welded or adhered, a hole (18) has been made in the short tubular segment (13) so that the screw (60) of the hinge passes through that hole. In this way, the tube is secured and trapped by the screw (60) of the hinge (FIG. 6), the male part of the hinge (30) fits perfectly with the female part of the hinge (31), in which (31) a long tubular segment (32) to which a hole (39) was made that has been welded or joined by special adhesives has been inserted into its hole (28). The male part of the hinge (30) incorporates a cylindrical pin (82) with circular grooves (83) where seals (84) are placed to prevent water leaks, where said seals (84) exert a radial force on the female part of the hinge In this specific case, only three grooves and three seals are being used, but it is possible to add more grooves with their respective seal to increase said radial force. The female part of the hinge (31) incorporates a box (81) that receives the cylindrical pin (82). Likewise, it includes a hole with parallel flat faces with curved faces (86) that receives the rim (65) of the screw (60), this hinge is secured by a screw (60) which, in its head, (80) incorporates grooves (61) for their respective seals (62). In this specific case, only three slots and three stamps are being used, but it is possible to add more slots with their respective stamp. These stamped grooves are in correspondence with the box (85) of the male part of the hinge (30). Likewise, the other end of the screw (60) incorporates a series of smaller diameter grooves (63) that receive the seals (64). In this specific case, only three slots and three stamps are being used, but it is possible to add more slots with their respective stamp. The screw (60) incorporates a rim (65) that is in correspondence with a hole with parallel flat faces with curved faces (86), both the rim and the hole with parallel flat faces with curved faces, are perfectly coupled avoiding that said screw moves on its own axis and the hinge can be adjusted by means of a lever nut (37). The screw (60) ends with a thread (66) that protrudes from the hinge and serves as a guide for the plate washer (38). The thread (66) of the screw receives the lever nut (37) which, when tightened with axial movement, adjusts the position of the tubular segments as the user wishes.

This second set of hinge mechanism, together with the short and long tubular segments, is the principle of sealed mobility of the System for shower heads, with rotating body, flow regulator, articulated arm, wall support and reinforced connector, in where said hinge mechanism includes the necessary elements to offer a free passage of the fluid coming from the hydraulic network previously installed through the first set. In addition to incorporating the elements already described, such as the synthetic material seals placed with such precision that it is possible for them to act with the radial force required to keep the tubular segments in position and keeping the mechanism totally sealed, preventing water leaks. In this second set, the male part of the hinge (30) is fixed to the reinforced connector (10), so the female part (31) is the one that has movement in conjunction with the first long tubular segment (32). The farthest end of the first long tubular segment (32) has been introduced into the hole (43) of the female part of the hinge (70) and a hole (39) has been made in it; the female part of the hinge (70) fits perfectly with the male part of the hinge (71). In this case, the female part of the hinge (70) is the one that remains fixed to the end of the long tubular segment (32) and the male part (71) is the one that moves relative to the female part (70) of the hinge. The end of the long tubular segment (29) is inserted into the hole (44) of the male part of the hinge (71), in which a hole (45) has been made and said segment has been welded or joined by special adhesives. The male part of the hinge (71) incorporates a cylindrical pin (82) with grooves (83) where seals (84) are placed to prevent water leaks and exert a radial force on the female part of the hinge. In this specific case, only three grooves and three seals are being used, but it is possible to add more grooves with their respective seal to increase the radial force. The female part of the hinge (70) incorporates a box (81) that receives the cylindrical pin (82). Likewise, it includes a hole with parallel flat faces with curved faces (86) that receives the rim (65) of the screw (60). This hinge is secured by a screw (60) that in its widest part (80) incorporates grooves (61) for their respective seals (62). In this specific case, only three slots and three stamps are being used, but it is possible to add more slots with their respective stamp. These stamped grooves are in correspondence with the box (85) of the hinge. Likewise, at the other end it incorporates a series of smaller diameter grooves (63) that receive the seals (64). In this specific case, only three slots and three stamps are being used, but it is possible to add more slots with their respective stamp. The screw (60) incorporates a rim (65) that is in correspondence with the hole (86), both the rim and the hole have two parallel flat faces and two curved faces, in such a way that they fit perfectly to prevent said screw (60) rotates on its own axis achieving that the lever nut (37) produces the axial force on the male and female part of the hinge. The screw ends with a thread (66) that protrudes from the hinge and serves as a guide for the plate washer (38). The thread (66) of the screw (60) that receives the lever nut (37) and when tightening adjusts the position of the tubular segments as the user wishes.

This third set of hinge mechanism provides the System for shower heads, with rotating body, flow regulator, articulated arm, wall support and reinforced connector unlimited mobility of the second long tubular segment (29), which, at its end, is inserted into the hole (53) of the rotating body with regulator (34) with a threaded projection (46). This second tubular segment has a notch (50) that is in correspondence with the threaded hole (48), where an oppressor (49) is located that prevents said rotating body with regulator (34) from being released from the tubular segment (29). Two slots (51) have been incorporated into the hole (53) of the rotating body with regulator (34), but there can be more and they receive their respective seal (52). Likewise, said body (34) incorporates a transverse hole (47) where a bolt (103) is installed, to which grooves (104) with their respective seals (105) have been incorporated on each side of the bolt conduit (106). In addition, a lever (36) has been incorporated that regulates the flow of water towards the shower head (21) by rotating on its own axis, since, when turning the bolt (103), its hole (106) goes away. aligning with the conduit (54) allowing the passage of water from the tubular segment (29).

The rotating body with regulator (34) incorporates a threaded projection (46) that is in correspondence with the threaded hole (23) of the shower head holder (20). The shower head holder incorporates a male thread (40) that is in correspondence with the female thread (41) of the shower head (21). Saying shower head holder (20), incorporates 2 slots (24) with their respective sealing element (25) to prevent water leaks. The number of slots and seals can be varied for convenience. This fourth assembly, which contains the end of the second long tubular segment, the rotating body with regulator rotates freely about the longitudinal axis of the second long tubular segment 360° (99). In addition, it provides a flow regulator (35, 36, 42, 103) and a shower head holder (20) with male thread (40) that receives the female thread (41) of the shower head (21) with holes (22) and knurled (26) and that, in addition, can receive any shower head with a female thread.

Both the reinforced connector (10) and the short and long tubular segments (13, 29 and 32), the hinges (30, 31, 70 and 71) with their respective screw (60), their washer (38) and their internal sealing means as well as the lever nut (37) together with the rotating body with regulator (34) and the shower head holder (20) with the shower head (21) with holes (22) form a System for shower head, with rotating body, flow regulator, articulated arm, wall bracket and hermetically sealed reinforced connector that conducts the water from the house's hydraulic network and also allows the position of the shower head to be adjusted as the user wishes without wasting it leaking water.

As can be seen, said system for a shower head with a flow regulator, articulated arm, wall support and reinforced connector for water supply provides a greater possibility of positioning the shower head thanks to its innovative hinge made up of two female and male parts, the short and long tubular segments are attached to each part of the hinge and are caught by the hinge screw, this hinge allows fine adjustment of the position of the long tubular segments by the internal relationship of their components since they have been machined with high precision in such a way that the seals, which prevent water leakage, also serve as a radial resistance force that prevents the tubular segments from rapidly loosening when turning the ergonomic lever nuts easily manipulated, providing security in the management of said system.

A special embodiment of this system for shower heads, with a rotating body, flow regulator, articulated arm, wall support and reinforced connector, shows a first long tubular segment (110) twice the size of the second long tubular segment (29). which allows a greater range of the shower head, giving it greater versatility to meet the special needs of people with disabilities, sick people and children.

One of the main characteristics achieved with this System for shower heads, with a rotating body, flow regulator, articulated arm, wall support and reinforced connector, is the wide variety of positions that can be achieved with it, thanks to its The fastening system to the wall and its support plate allows it to easily resist the movements and efforts inherent in the handling of the tubular segments without, therefore, representing a risk to the user.

The circular movements of the long tubular segments can be established as follows, considering the hinge closest to the reinforced connector for the first long tubular segment, the male part of the hinge is fixed and the female part rotates with the center of the horizontal as its axis. of the hinge, the movement of the first long tubular segment is limited to only 180° (90), at its end a hinge has been included, where said segment The tubular part is attached to the female part of the hinge and is fixed in relation to said long segment, the male part of the hinge being the one that rotates freely up to 360° (101), the end of the second tubular segment incorporates a rotating body with a regulator and shower head that rotates freely about the longitudinal axis of the second long tubular segment, in such a way that the first long tubular segment in its 180° movement moves the hinge at its end and this in turn moves the second long tubular segment, for Therefore, the first tubular segment will always have a displacement of 180° and the second long tubular segment will have a movement relative to the first long tubular segment, considering that the first long tubular segment can rotate in a circular movement approximately 180°, the second long tubular segment would have its axis in the furthest hinge therefore rotates having as its center the horizontal axis of the hinge, this second long tubular segment that incorporates the cu Rotating erpo with regulator and the shower head, it can rotate 360°, therefore the position of the shower head in space has in its first long tubular segment a range of movement of 180° with the axis fixed on the hinge and the second long tubular segment has an axis that can be located at any point of the circular movement of the first long tubular segment and therefore the second long tubular segment can rotate 360° and moving its axis according to the position of the first long segment with this combination of movements the user has at his disposal a wide range of positions for the shower head offering the necessary comfort when taking his shower, even the rotating body assembly with regulator, shower head holder and shower head can rotate 360° on the axis longitudinal of the second long tubular segment, the fully extended system provides 180° (100) movement, increasing the versatility of this shower head system, flow regulator, articulated arm, wall bracket and reinforced connector for water supply.

1. System for shower head, with rotating body, flow regulator, articulated arm, wall support and reinforced connector, which enables unlimited circular movement of long tubular segments, essentially characterized by comprising a reinforced connector that connects to the water supply pipe in a bathroom, and which is secured by a stamped plate support, which is attached to the wall either by means of expanding screws or special adhesives, a tubular segment is integrated into said reinforced connector short by available means such as welding, special adhesives or threading, which is in correspondence with the hole in the pin part of the hinge into which it is inserted and is attached to the walls of the pin part of the hinge, once it has been positioned in said hinge, a hole is made that is in correspondence with the duct of the hinge; The male part of the hinge has a cylindrical pin with 3 grooves that receive their corresponding seals and that fits into the box of the female part of the hinge that has a hole that in turn receives the first long tubular segment that is joined to its walls by welding or special adhesives and that once positioned, a hole is made, once the two female and male parts of the hinge are fitted, a screw with slots and seals that fit very precisely in the box of the male part of the hinge is positioned and on the internal walls of the female segment of the hinge, even going through the tubular segments attached to each part of the hinge, said screw has a rim with two parallel faces and two curved faces in correspondence with the hole with two flat faces and two curved faces from the female part of the hinge, a threaded projection protrudes that receives the plate washer and the lever nut that adjusts the position of the first long tubular segment as well as én exerts the axial force on the screw and the hinges, said first tubular segment at its farthest end from the first hinge is incorporated into the hole of the female part of the hinge also joined by welding or special adhesives to the internal walls of said part to which a hole has been made, said female part fits through the box with the circular pin with grooves and seals of the male part that also receives in its hole the second long tubular segment that is joined by welding or special adhesives to the walls of the male part of the hinge and to which a hole has also been made, once the two parts of the hinge are fitted together, a screw is positioned with slots and seals that fit very precisely in the box of the male part of the hinge and in the internal walls of the female part of the hinge, even going through the tubular segments attached to each part of the hinge, said screw has a flange with two parallel faces and two curved faces in correspondence with the hole with two flat faces and two flat faces. curves of the female part of the hinge, a threaded projection protrudes that receives the plate washer and the lever nut that adjusts the position of the second long tubular segment, which at its opposite end is inserted into the box of the rotating body with regulator with a threaded projection, this second tubular segment has a notch that is in correspondence with the threaded hole of the rotating body with regulator and that receives an oppressor that prevents the rotating body with regulator from detaching from the second long tubular segment and that in turn allows the swivel body with regulator to rotate 360° about the transverse axis of the second long tubular segment, said swivel body with regulator has two seal grooves that are in contact with the end of the tubular segment to prevent water leakage, this body has a threaded projection that receives the shower head holder with male thread to fit with the female thread of the shower head with holes, in said head holder two grooves with seals have been incorporated that are in contact with the upper surface of the shower head to prevent water leakage, said head holder due to its male thread it can receive any other shower head with a female thread.

2. System for shower head, with rotating body, flow regulator, articulated arm, wall support and reinforced connector according to claim 1, characterized in that the short or long tubular segment that is inserted into the male and female parts of the hinge It is joined by welding or special adhesives and a hole is made through which the screw passes with slots and seals and a threaded projection that is incorporated into the slot secured by the plate washer and the lever nut, which traps the screws. tubular segments preventing them from coming off the hinges.

3. System for shower head, with rotating body, flow regulator, articulated arm, wall support and reinforced connector according to claim 1, characterized in that the male part of the hinge incorporates a protrusion with grooves and seals that is in correspondence with the box of the female part of the hinge, and that the number of grooves and seals can vary, also incorporates a screw with a threaded projection that protrudes from one end and receives a washer, in correspondence with the lever nut that exerts the axial force between the female and male parts of the hinge as well as allowing the position adjustment of the tubular segments.

4. System for shower head, with rotating body, flow regulator, articulated arm, wall support and reinforced connector according to claim 1, characterized in that the internal seals of the hinge provide the radial resistance force to inhibit or allow the relative motion between tubular segments of the arm, the number of said seals can be increased as required.

5. System for shower head, with rotating body, flow regulator, articulated arm, wall support and reinforced connector according to claim 1, characterized in that the first long tubular segment is twice the size of the second long tubular segment, to Provide a suitable shower head position for the disabled, sick and children.

6. System for shower head, with rotating body, flow regulator, articulated arm, wall support and reinforced connector according to claim 1, characterized in that the rotating body with regulator can rotate 360° according to the transverse axis of the second tubular segment long due to the notch made at the end of the long tube and that is in correspondence with the threaded hole and the oppressor of the rotating body with regulator and that is sealed by the seal grooves contained in said body.

7. System for a shower head, with a rotating body, flow regulator, articulated arm, wall support and reinforced connector according to claim 1, characterized in that said head incorporates a male thread that can receive any shower head with a female thread It features two seal slots to prevent leaks.

8. System for shower head, with rotating body, flow regulator, articulated arm, wall support and reinforced connector according to claim 1, characterized in that the heavy-duty connector in correspondence with the support plate provides the system with reinforcement adequate to withstand the efforts to which it will be subjected.
